(19) United States
(12) Patent Application Publication
(10) Pub. No.: US 2024/0141799 A1
(43) Pub. Date: May 2, 2024

(54) Disassembly and reassembly of a generator rotor in a plant

(71) Applicant: Siemens Energy Global GmbH & Co. KG, München (DE)

(72) Inventors: Florian Lang, Berlin (DE); Oliver Rottländer, Erlangen (DE); Andreas Müller, Berlin (DE); Mark Grasso, Wellington, FL (US); Torsten Löber, Baiersdorf (DE)

(21) Appl. No.: 17/979,477

(22) Filed: Nov. 2, 2022

(51) Int. Cl. F01D 15/10; F01D 25/28

(52) U.S. Cl. CPC F01D 15/10; F01D 25/285; F05D 2220/766; F05D 2230/70

(57) ABSTRACT

The invention relates to a method for removing a rotor (100) of a generator (4) in a turbine plant (1) in which the generator (4) is driven by at least one turbine (7), in particular a gas turbine or steam turbine, in which the turbine (7) is opened and the rotor (39) of the turbine (7) is removed, and only then is the rotor of the generator (4) pulled out of the generator (4) so that it is located in the lower housing half of the turbine (7).

The invention relates to a method of removing a rotor of a generator in a plant and reassembling it.

Large generators such as those used for power generation need to be inspected or overhauled after long periods of operation.

In many cases robots already do the inspection or repair, but in some cases a removal of the rotor is necessary.

Normally, the generator is opened and the rotor can simply be pulled out from one side.

There are structural situations in which the latter possibility is not possible.

It is therefore the task of the invention to solve the abovementioned problem.

The task is solved by a method according to claim 1.

In the subclaims further advantageous measures are listed, which can be combined with each other as desired to achieve further advantages.

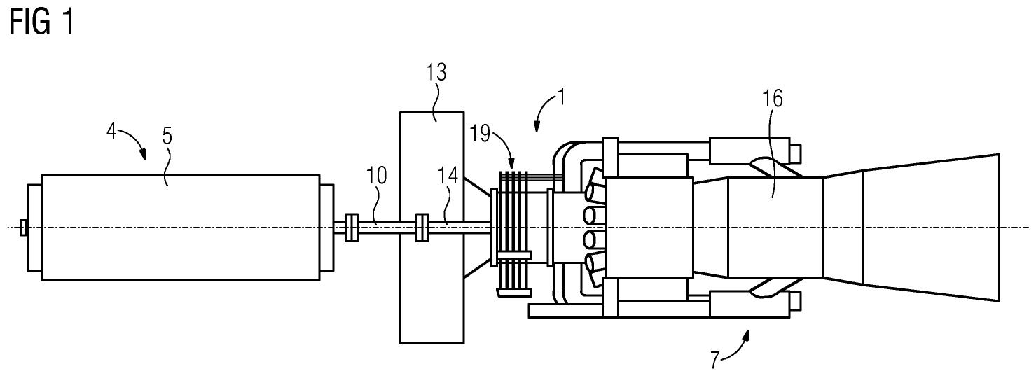

FIGS. 1 to 14 show schematically the sequence of the process according to the invention.

The figures and the description represent only examples of embodiments of the invention.

The invention is explained in more detail only by way of example and in particular by means of a gas turbine.

It can also be applied to a steam turbine.

It shows:

FIG. 1 shows the initial situation of an exemplary turbine plant 1,

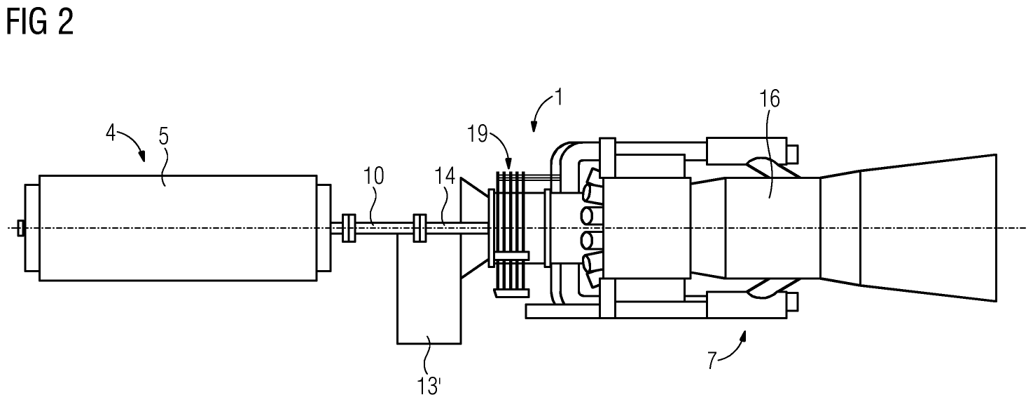

FIGS. 2-13 show the preparations and the individual steps for removing the rotor from the generator,

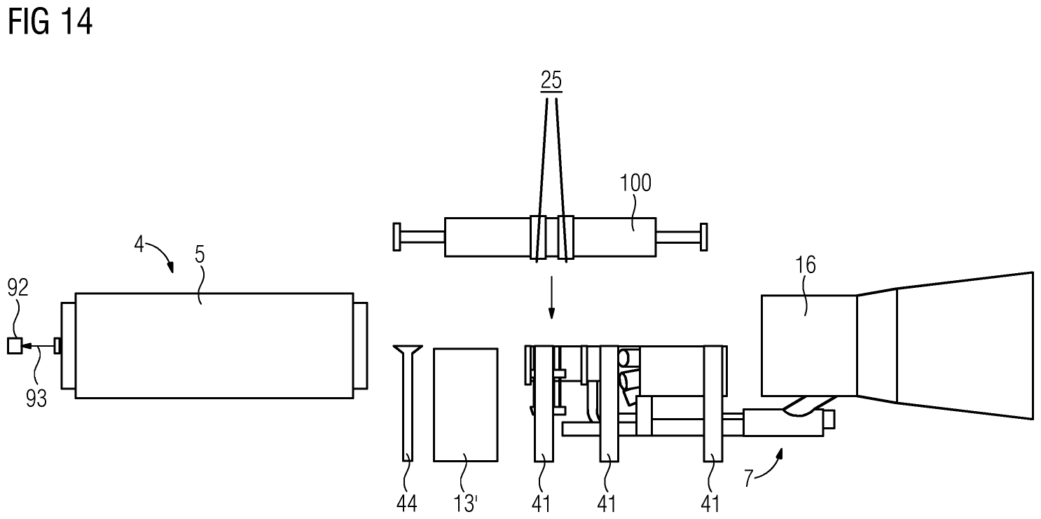

FIG. 14 shows the start of re-assembly.

A plant 1 comprises preferably a single-shaft plant.

A generator 4 for generating electricity is connected to a turbine 7, in particular a gas turbine 7 as an example only, to be driven by the gas turbine 7 so that electricity can be generated.

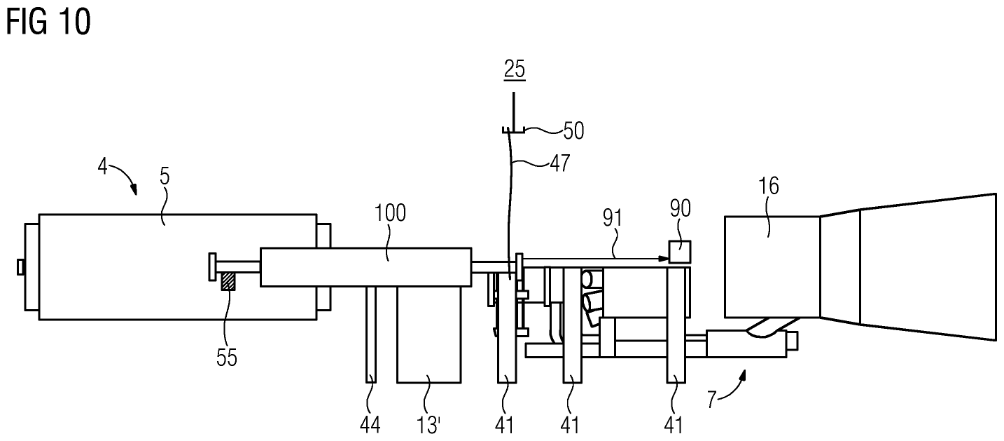

The generator 4 has a generator rotor 100 (FIG. 10ff), which is to be removed from the generator housing 5 off the generator 4 for inspection or revision.

The generator 4 may be arranged on either side of the turbine 7, here gas turbine 7, i.e., on the side of the hot gas path 16 or as here on the side of a compressor 19.

The generator 4 is connected to the gas turbine 7 preferably, also optionally, by an intermediate shaft 10.

In the case of a steam turbine, the generator 4 is preferably directly connected to the steam turbine.

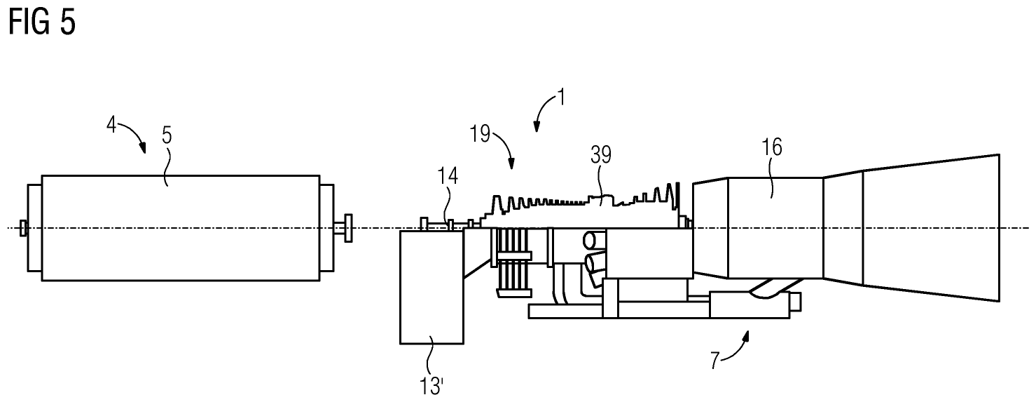

The gas turbine 7 with the compressor 19 also has a turbine rotor 39 (FIG. 5), the turbine rotor 39 also having a turbine shaft 14.

The shafts 10, 14 are shown graphically in FIG. 1, although not actually visible or only partially visible.

In this version of the gas turbine 7, but not restrictively, an intake housing 13 is provided between the generator 4 and the gas turbine 7.

The generator rotor 100 is to be pulled out over the gas turbine 7 in the direction of the gas turbine 7.

Therefore, a corresponding clearance must be created on this side of the generator 4 around the gas turbine 7.

This is done here, for example, by removing the intake housing 13 or only the upper part of the intake housing 13 (FIG. 2).

Preferably, a lower part 13′ of the intake housing 13 remains in position.

Access to the intermediate shaft 10, if present, must also be exposed.

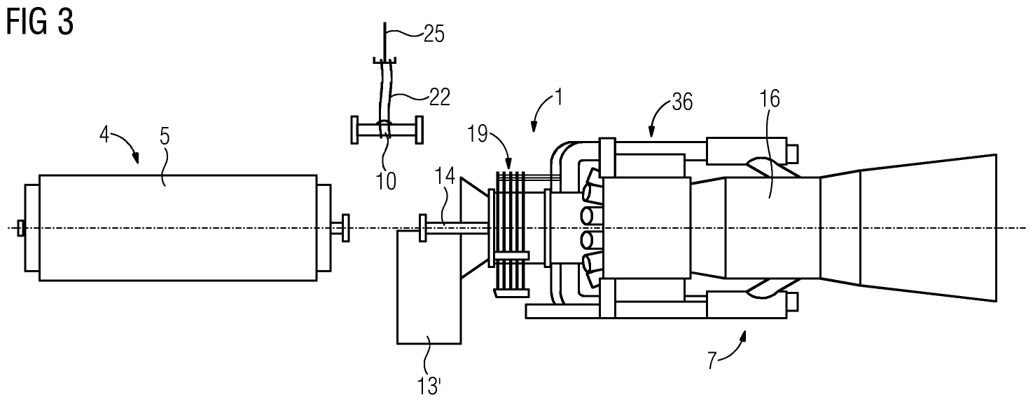

Then the intermediate shaft 10 can be detached from the generator rotor 100 and turbine shaft 14 and lifted out (FIG. 3).

Preferably, a crane 25 of the plant with a hook and belts, ropes or similar 22 is used for this purpose.

The crane 25 can also be external, i.e., the crane 25 is provided for this work. This is especially the case if there is no machine hall where a generator and turbine are located. This statement for a crane 25 applies to the entire process described here.

In the next step, feed lines 36 are removed above a rotor housing 28.

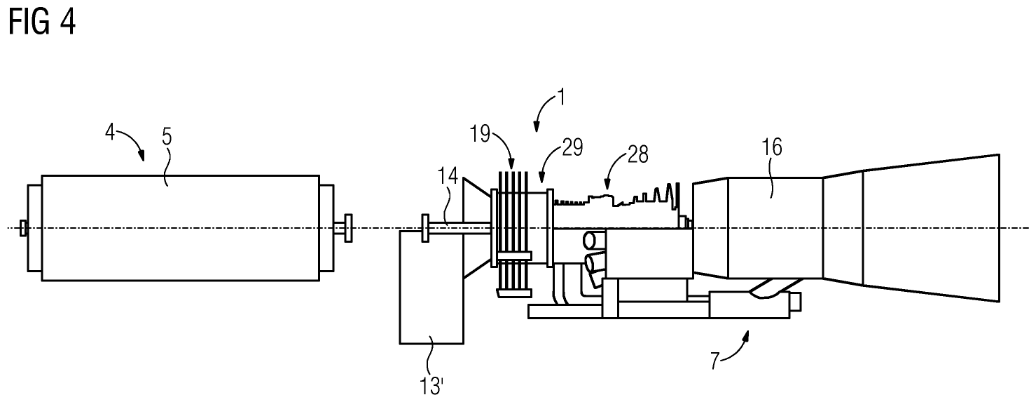

Or the feed lines 36 are removed together with the rotor casing 28 so that the latter is at least partially exposed (FIG. 4).

Then further housing parts 29 of the gas turbine 7 are removed until the turbine rotor 39 of the gas turbine 7 is fully exposed (FIG. 5).

The sequence of the upper housing parts to be removed can also vary and is not fixed.

If necessary, diffuser parts 42 and housing are also removed if this is necessary due to the length of the generator rotor 100.

Depending on the turbine type, only one housing part may have to be removed to expose the turbine rotor 39.

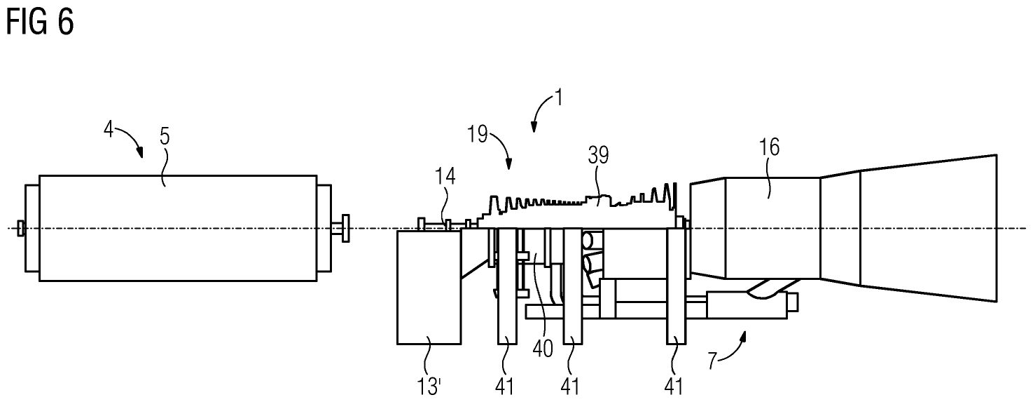

In an intermediate step (FIG. 6) or later, supports 41 are attached to the lower part 40 of the housing of the gas turbine 7 so that the generator rotor 100 of the generator 4 can be supported there.

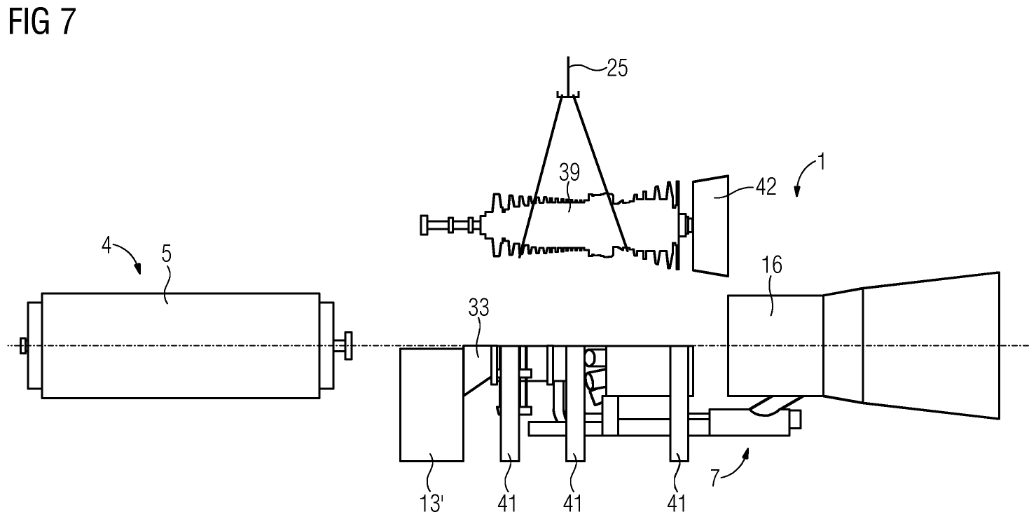

The turbine rotor 39 with or without diffuser section 42 is then removed (FIG. 7) and supported.

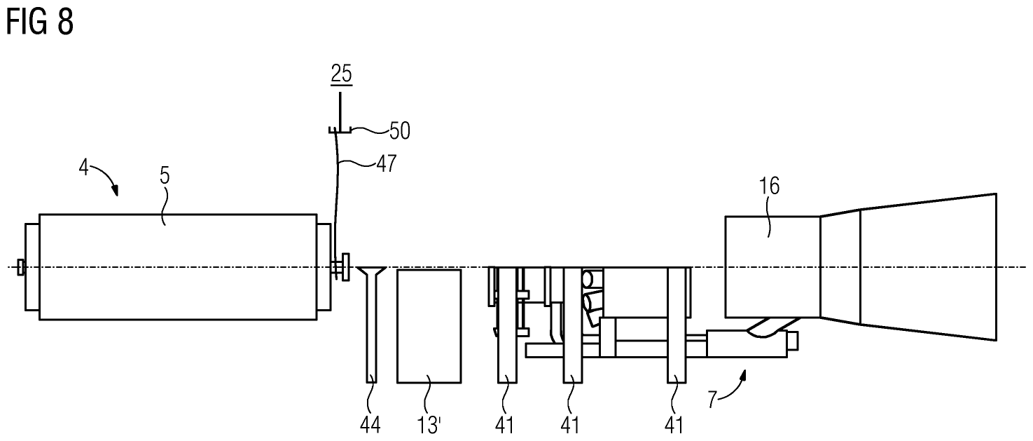

A front bearing 33 (FIG. 7) of the turbine rotor 39 of the gas turbine 7 may have to be removed completely for space reasons (FIG. 8), since the bearing 33 is not in two parts.

Now the rotor 100 of the generator 4 can be pulled out.

In preparation for this, a rope 47 or other is attached to a hook 50 of a crane 25 at one end of the generator rotor 100 (FIG. 8).

For mechanical support, another rotor support 44 is provided between generator 4 and turbine 7. This is optionally done depending on the weight of the generator-rotor 100 and/or the loading capacity of the crane 25.

Thus, one end of the generator-rotor 100 is quasi supported.

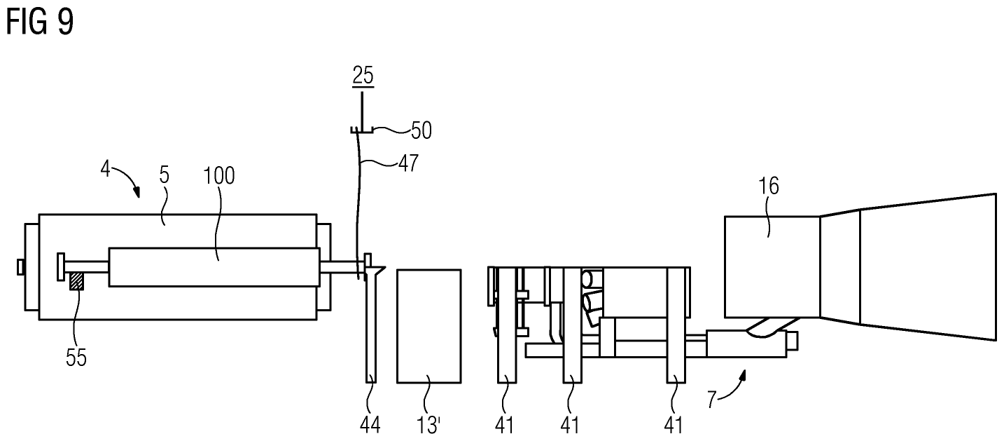

The other end of the generator rotor 100 in the generator 4 is supported by a pedestal 55 at the opposite end (FIG. 9).

The pedestal 55 is moved while the generator rotor 100 is pulled out in direction 91 (FIG. 10).

A rope or chain winch 90 is used for this.

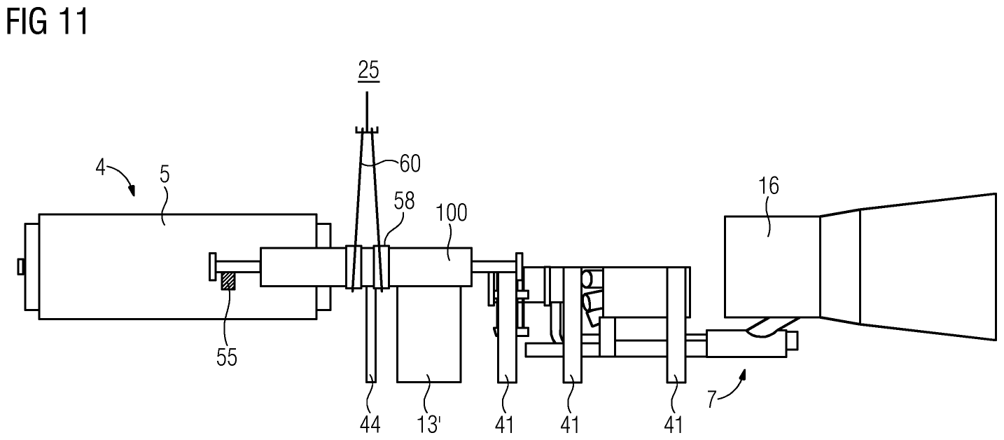

When the generator rotor 100 is pulled out by at least 50% or up to the center of gravity (FIG. 11), it is embraced by ropes, in particular at center 58, and attached to a crane 25 with hooks.

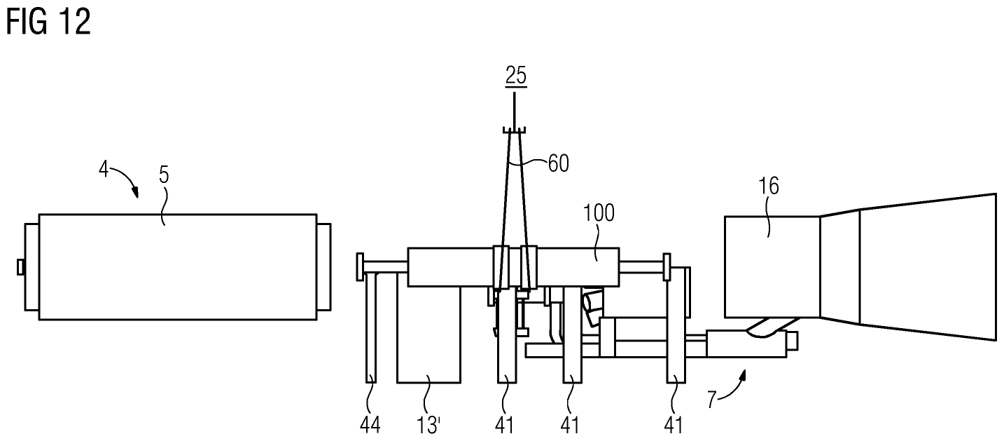

Thus, the generator rotor 100 is completely supported and does not need any more support by pedestal 55 or rotor support 44 and can be pulled out further until it 100 is completely outside the generator 4 (FIG. 12).

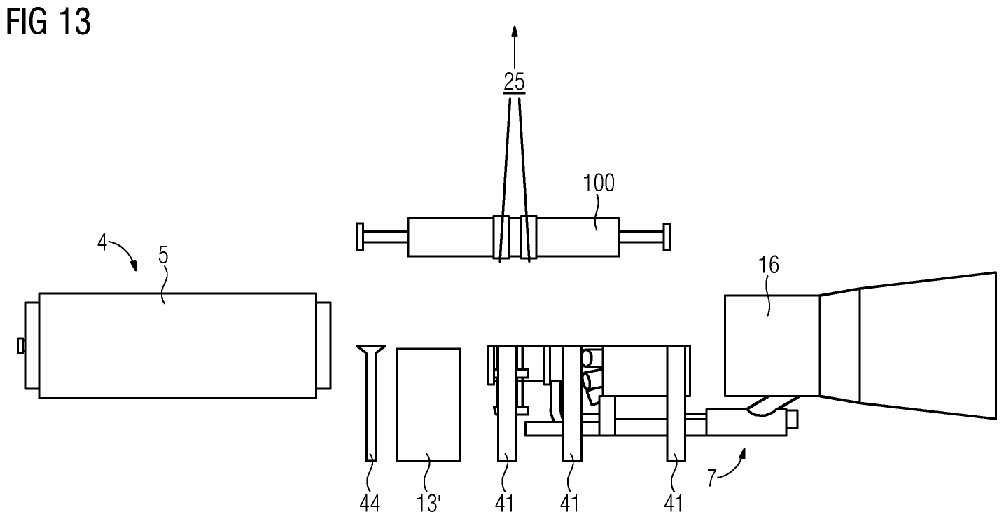

Then the generator rotor 100 can be completely removed (FIG. 13).

This is indicated by the arrow pointing upwards which can be seen above the reference sign 25.

The generator rotor 100 is reassembled in the reverse order (FIG. 14).

The examined or, if necessary, reworked generator rotor 100 is lowered as indicated by the arrow between the generator rotor 100 and the open housing of the gas turbine 7.

The generator rotor 100 is only pulled in at the other end of the generator 4 in direction 93. For this purpose, a cable or chain winch 92 and also a pedestal 55 are used for this purpose.

When the generator rotor 100 is again in the housing 5, like the position as shown in FIG. 11, the central attachment to the crane 25 can be released and the crane 25 again grips the end of the generator rotor 100 according to the position as shown in FIG. 10.

Then the intermediate shaft 10, if present, is reattached.

After that, the rotor 39 of the gas turbine 7 is installed again and all other housing parts are reassembled.

At the end or before, the supports 41, 44 can be removed.

Ultimately, the turbine, i.e., also a steam turbine after removal of the upper housing part(s) and the rotor 39 or the rotor of the steam turbine must have enough space for the diameter of the generator rotor 100 and its length.

In the case of the steam turbine, this may be the rotor of the high-pressure part, if necessary, of further or other pressure stages (medium-pressure, low-pressure stage) and thus inevitably at least corresponding upper housing parts of these stage(s).

Depending on the application, in particular when opening the steam turbine, an exciter unit of the generator must be disassembled.

1. A method for removing a rotor of a generator in a turbine plant, in which the generator is driven by a turbine, comprising:
opening a housing of the turbine
removing a rotor of the turbine; and
pulling the rotor out of the generator out of the generator so that it is located in a lower half of the housing of the turbine.

2. The method according to claim 1, further comprising disconnecting and removing an intermediate shaft which connects the turbine to the generator, before the rotor of the generator is pulled out.

3. The method according to claim 1, further comprising removing at least an upper half of an intake housing which is arranged between the turbine and the generator, before the rotor of the generator is pulled out.

4. The according to claim 2, further comprising removing at least an upper half of an intake housing which is arranged between the turbine and the generator, before the rotor of the generator is pulled out.

5. The method according to claim 1, further comprising mounting supports that support the loads of the rotor of the generator directly or indirectly via the lower half of the housing of the turbine.

6. The method according to claim 2, further comprising mounting supports that support the loads of the rotor of the generator directly or indirectly via the lower half of the housing of the turbine.

7. The method according to claim 3, further comprising mounting supports that support the loads of the rotor of the generator directly or indirectly via the lower half of the housing of the turbine.

8. The method according to claim 4, further comprising mounting supports that support the loads of the rotor of the generator directly or indirectly via the lower half of the housing of the turbine.

9. The method according to claim 1, further comprising mounting a pedestal that supports the rotor of the generator in a housing of the generator.

10. The method according to claim 2, wherein a pedestal supports the rotor of the generator in a housing of the generator.

11. The method according to claim 3, wherein a pedestal supports the rotor of the generator in a housing of the generator.

12. The method according to claim 4, wherein a pedestal supports the rotor of the generator in a housing of the generator.

13. The method according to claim 5, wherein a pedestal supports the rotor of the generator in a housing of the generator.

14. The method according to claim 6, wherein a pedestal supports the rotor of the generator in a housing of the generator.

15. The method according to claim 7, wherein a pedestal supports the rotor of the generator in a housing of the generator.

16. The method according to claim 8, wherein a pedestal supports the rotor of the generator in a housing of the generator.

17. The method according to claim 1, wherein the turbine is a gas turbine and the generator rotor is pulled out over the gas turbine.

18. The method according to claim 1, wherein the turbine is a steam turbine and the generator rotor is pulled out via the steam turbine.
